(19) United States
(12) Patent Application Publication
(10) Pub. No.: US 2026/0260154 A1
(43) Pub. Date: Sep. 3, 2026

(54) METHOD, DEVICE AND SYSTEM FOR TRAINING MODEL

(71) Applicant: Sony Group Corporation, Tokyo (JP)

(72) Inventor: Lingjuan LYU, Beijing (CN)

(73) Assignee: Sony Group Corporation, Tokyo (JP)

(21) Appl. No.: 18/863,663

(22) PCT Filed: May 12, 2023
(86) PCT No.: PCT/CN2023/093818

§ 371 Date: Nov. 7, 2024

(30) Foreign Application Priority Data
May 19, 2022 (CN) 202210554969.8

(51) Int. Cl. G06N 20/00

(52) U.S. Cl. CPC G06N 20/00

(57) ABSTRACT

The present disclosure relates to a method, apparatus, and system for training a model. Various embodiments about model training are described. In one embodiment, a method for training a model comprises acquiring an approximate dataset composed of open-world data, which is similar to an actual dataset; and training a model using the approximate dataset.

### CROSS-REFERENCE TO RELATED APPLICATIONS

The present application is based on and claims the priority to the Chinese application NO. 202210554969.8 filed on May 19, 2022, the disclosure of which is incorporated herein in its entirety.

### TECHNICAL FIELD

The present disclosure relates s generally to privacy protection, and specifically to privacy protection during model training.

### BACKGROUND

With the continuous development of deep learning technology, neural network models have been widely deployed on various systems and apparatuses including edge computing devices, for real-time interaction with users.

However, since the neural network models contain many parameters, a large amount of data and computing costs are typically required for training, while most commercial edge computing devices do not support model training with high computing complexity. To solve this problem, one technical route is to collect data to a high-computing power server for training. However, data sharing may result in unpredictable privacy leakage. In particular, in existing provisions of privacy laws in multiple countries, data is not allowed to leave the local. Another technical route is to perform model training locally using actual data, in particular, to perform fine-tuning on the basis of a model downloaded from a cloud, so as to improve the performance of the model on the actual data. However, model training will consume excessive resources and is therefore not applicable to a low-power edge computing device.

There are currently two types of privacy protection technology routes for model training. A first type is to use a differential privacy technique. However, this type of method has a significant influence on performance, and requirement of computing power is high, and convergence of training process is slow, so that actual application requirements cannot be met. The other type is to perform privacy processing on local data and further share the data to a server for model training. The privacy processing includes data encryption and privacy attribute decoupling. The former encrypts images or other data samples by using a traditional numerical encryption method, thereby ensuring usability of the data, while bringing a very high computing burden at the same time, which is not applicable to a low-power device. The latter requires pre-training of a feature extraction model with a decoupling capability and supervised learning of removing privacy information contained in features during the training, which on one hand depends on a pre-defined privacy policy, and on the other hand, may remove information important for a learning task at the same time, reducing the quality of the features.

Therefore, there is a need to effectively protect privacy of local actual data while ensuring performance of model training.

### SUMMARY

One aspect of the present disclosure relates to a method for training a model. According to an embodiment of the present disclosure, the method comprises: acquiring an approximate dataset composed of open-world data, which is similar to an actual dataset; and training a model using the approximate dataset.

One aspect of the present disclosure relates to a data processing method. According to an embodiment of the present disclosure, the data processing method comprises: acquiring an actual dataset; receiving a representative data sample set of an open-world dataset; performing feature matching on representative data samples with actual data; and returning matching results of the representative data samples with the actual data.

One aspect of the present disclosure relates to a method for generating a model. According to an embodiment of the present disclosure, the method for generating a model comprises: generating a model by performing the steps of the method for training a model according to the embodiment of the present disclosure.

One aspect of the present disclosure relates to a training apparatus. According to an embodiment of the present disclosure, the apparatus comprises a training data acquisition module, configured to acquire an approximate dataset composed of open-world data, which is similar to an actual dataset; and a training module, configured to train a model using the approximate dataset.

One aspect of the present disclosure relates to a data processing apparatus. According to an embodiment of the present disclosure, the data processing apparatus comprises a data collection module, configured to acquire an actual dataset; an exchange module, configured to receive a representative data sample set of an open-world dataset; and a feature matching module, configured to perform feature matching on representative data samples with actual data, wherein the exchange module is further configured to return matching results of the representative data samples with the actual data.

One aspect of the present disclosure relates to a system for training a model. According to an embodiment of the present disclosure, a system for training a model comprises the training apparatus according to the embodiment of the present disclosure; and the data processing apparatus according to the embodiment of the present disclosure.

Yet another aspect of the present disclosure relates to a computer-readable storage medium having one or more instructions stored thereon. In some embodiments, the one or more instructions may, when executed by a processor, cause the processor to perform the steps of the method according to the embodiment of the present disclosure.

Yet another aspect of the present disclosure relates to a computer program product comprising one or more instructions. In some embodiments, the one or more instructions may, when executed by a processor, cause the processor to perform the steps of the method according to the embodiment of the present disclosure.

The above summary is provided to summarize some exemplary embodiments to provide a basic understanding of aspects of the subject matter described herein. Thus, the above features are merely examples and should not be construed to narrow the scope or spirit of the subject matter described herein in any way. Other features, aspects, and advantages of the subject matter described herein will become apparent from the specific implementation described below in conjunction with the accompanying drawings.

### BRIEF DESCRIPTION OF THE DRAWINGS

When the following detailed description of the embodiments is considered in conjunction with the accompanying drawings, a better understanding of the present disclosure may be obtained. The same or similar reference numbers are used in the drawings to denote the same or like components. The accompanying drawings, together with the specific description below, which are incorporated in and form a part of this specification, are used for illustrating the embodiments of the present disclosure and explaining principles and advantages of the present disclosure. In the drawings:

FIG. 1A is a flow diagram illustrating an example of steps of a method for training a model according to an embodiment of the present disclosure.

FIG. 1B is a flow diagram illustrating an example of sub-steps of a step of acquiring an approximate dataset according to an embodiment of the present disclosure.

FIG. 1C is a flow diagram illustrating an example of sub-steps of a step of selecting representative data samples according to an embodiment of the present disclosure.

FIG. 2 is a flow diagram illustrating an example of steps of a data processing method according to an embodiment of the present disclosure.

FIG. 3 is a schematic diagram illustrating an example of configuration of a system for training a model having a training apparatus and a data processing apparatus therein according to an embodiment of the present disclosure, where main functional modules composing the apparatus and information exchange are illustrated.

FIGS. 4A-4C are schematic diagrams illustrating a plurality of learning scenarios for a solution for training a model according to embodiments of the present disclosure.

FIG. 5 illustrates an example block diagram of a computer that can be implemented as a training apparatus, data processing apparatus, or system for training a model according to an embodiment of the present disclosure.

While the embodiments described in this disclosure may be susceptible to various modifications and alternative forms, specific embodiments thereof have been shown as examples in the drawings and are described in detail herein. It should be understood, however, that the drawings and detailed description thereof are not intended to limit the embodiments to specific forms disclosed, but rather to cover all modifications, equivalents and alternative solutions falling within the spirit and scope of the claims.

### DETAILED DESCRIPTION

Representative applications of the apparatus, method and other aspects according to the present disclosure are described below. The description of these examples is merely to add context and help understanding the described embodiments. Therefore, it is apparent to those skilled in the art that the embodiments described below may be implemented without some or all of the specific details. In other cases, well known process steps have not been described in detail to avoid unnecessarily obscuring the described embodiments. Other applications are possible, and the solutions of the present disclosure are not limited to these examples.

The inventors have recognized that compared to a general model, a model trained using local actual data can be more accurately applicable to a specific local application scenario. However, performing model training directly locally using the actual data is not applicable to a low-power computing device (a local edge device such as a sensor), while performing training by collecting the actual data to a high-computing power computing device (such as a cloud server) may result in unpredictable privacy leakage. In addition, the model trained by directly using the actual data may leak privacy information in the actual data. For example, in some cases, it may be determined whether target data is used for training a model by observing an output of the target data on the model, thereby acquiring member privacy information of the target data. More specifically, for example, if facial image data captured by a camera is directly used for model training, a trained model may be maliciously utilized, for example, to infer, by an output of the model, whether someone has entered an observation range of the camera, such as an unmanned supermarket.

The inventors have also recognized that increasing the amount of training data is beneficial for achieving efficient learning to obtain a high-accuracy model, however, in an existing privacy protection learning method, sharing of data is typically limited to some extent.

Therefore, it is very necessary to acquire a large amount of valuable training data while protecting privacy information and ensuring computing power required for training.

To this end, the applicants have proposed in this disclosure to sample a large number of data samples that match the actual data from massive and diverse open-world data, and train a model on these non-privacy-sensitive data samples. On the one hand, the actual data collected locally is only used for matching data locally and is not used by other modules, and on the other hand, there is no need for model training with a high-computing power requirement locally. Therefore, the model trained based on the large amount of open-world data will not leak privacy information of the actual data, and can ensure the actual application value of the model at the same time. The solution of the present disclosure is applicable to all scenarios, such as a smart city and a smart supermarket, where there are a need for privacy protection on actual data for training a model and a need for a large amount of data. In some embodiments, the solution of the present disclosure can introduce time sequence information of a plurality of frames of a monitoring video, and is thus applicable for privacy protection of, for example, a user action trajectory.

The solution of the present disclosure is also applicable to scenarios where a high-energy consumption learning task is transferred from a low-computing power edge device to a high-computing power server.

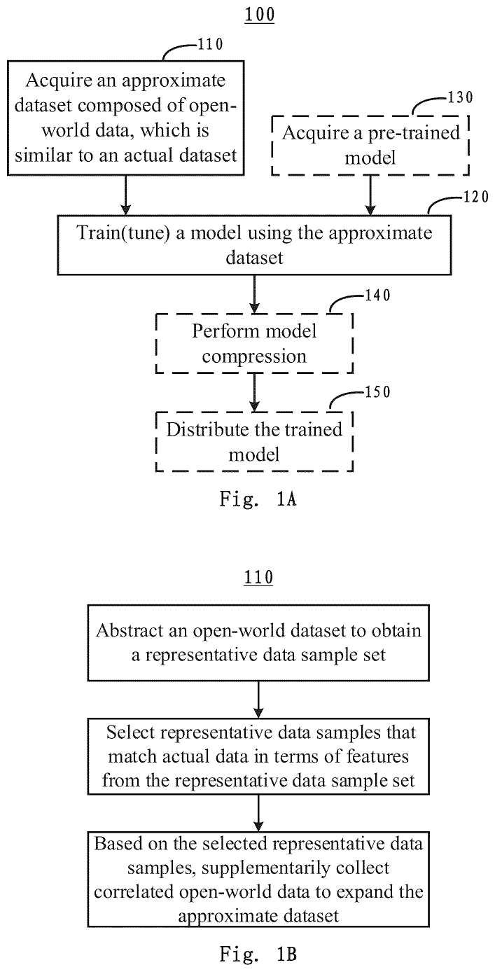

FIG. 1A illustrates a flow diagram of an example of steps of a method for training a model according to an embodiment of the present disclosure. FIGS. 1B-1C illustrate a flow diagram of an example of sub-steps of part of steps of a method for training a model according to an embodiment of the present disclosure. The method for training a model according to the embodiment of the present disclosure may be performed by any apparatus including a processing device, for example, by a high-computing power server (such as a cloud server).

As shown in FIG. 1A, the method 100 for training a model according to the embodiment of the present disclosure may essentially comprise the following steps:
step 110, acquiring an approximate dataset composed of open-world data, which is similar to an actual dataset; and
step 120, training a model using the approximate dataset.

Open-world data may be understood as public data resources that can be legally obtained from any source, including network images, public datasets, and the like. The inventors have recognized that although the massive open-world data can provide abundant and diverse data samples, it is disadvantageous to train a model directly using the open-world data, because on one hand, a dispersed data distribution is not conducive to fast convergence of the model, and on the other hand, for a specific application scenario, a large amount of data having a great difference in distribution from actual data will affect the accuracy of the model.

Thus, in the embodiment according to the present disclosure, an approximate dataset composed of open-world data and similar to an actual dataset is acquired, and a model is trained using the approximate dataset.

The approximate dataset being “similar” to the actual dataset may be understood as the approximate dataset having a similar data distribution to the actual dataset. A metric may be that a loss obtained by training on the approximate dataset is close to that on the actual dataset. Therefore, training the model using the approximate dataset can improve the performance of the model on the actual data.

Optionally, in some embodiments, the method 100 for training a model may further comprise acquiring a pre-trained model (step 130). Thus, training the model using the approximate dataset (the step 120) comprises tuning the pre-trained model using the approximate dataset.

In some embodiments, it is possible to collect data from the open world and pre-train a model on a collected pre-trained dataset to obtain the pre-trained model. For example, pre-training can be performed using common data in ImageNet. However, the present disclosure is not limited thereto. For example, in some embodiments, a pre-trained model may be downloaded from a cloud. Alternatively, in some embodiments, a pre-trained model may be downloaded from an external storage device. Those skilled in the art will readily appreciate that the manner of acquiring the pre-trained model is not limited thereto and may be selected as needed.

An example of sub-steps of the step of acquiring the approximate dataset (the step 110) will be illustrated in detail below in conjunction with a flow diagram of FIG. 1B. Those skilled in the art will readily appreciate that the method of acquiring the approximate dataset shown in FIG. 1B is only an example, and the present disclosure is not limited thereto, and those skilled in the art can also obtain an approximate dataset similar to an actual dataset using various existing open-world data acquiring, sampling, collecting, selecting, picking, screening, filtering, and other methods in conjunction with the concepts disclosed in the present disclosure.

As shown in FIG. 1B, in some embodiments, acquiring the approximate dataset may comprise abstracting an open-world dataset D to obtain a representative data sample set S_{q} (step 112).

In some embodiments, the open-world dataset D may be collected according to an application scenario to which the actual data belongs. For example, in the case where the application scenario is a smart city or a smart unmanned supermarket, data samples of a class adapting to the application scenario may be selected to compose the open-world dataset D. Advantageously, this manner enables faster and more accurate matching of a sensor data distribution and determination of the approximate dataset. However, those skilled in the art will readily appreciate that the present disclosure is not limited thereto, e.g., data samples may be randomly collected from the open world to form the open-world dataset D.

In some examples, the open-world dataset D may have the same or similar data distribution as the pre-trained dataset used for acquiring the pre-trained model. Alternatively, the open-world dataset D may have a different data distribution from the pre-training dataset.

Here, “abstracting” the open-world dataset D may refer to various methods of refining massive data in the open-world dataset to obtain representative data samples, including, but not limited to, an unsupervised clustering method.

The inventors have recognized that a feature layer, particularly a penultimate layer, of a neural network has inherent functions of feature extraction and data clustering, and can be used for extracting features from data and clustering the data.

Thus, in some embodiments, the step 112 of abstracting the open-world dataset comprises performing feature extraction and clustering on the data in the open-world dataset using the pre-trained model.

For example, the feature extraction and clustering in the step 112 may be performed using the pre-trained model acquired in the step 130. But the present disclosure is not limited thereto.

It is assumed that the pre-trained neural network is f_{θ}. By removing a last layer of the neural network and using the retained feature layer located at the penultimate layer as an output, a neural network φ may be obtained. Extraction of hidden-layer features of the open-world dataset D and clustering may be performed by using φ as a feature extractor, to obtain C cluster centers of C clusters in total, each cluster center being regarded as a representative data sample of the cluster, so that all representative data samples can compose the above representative data sample set S_{q}. However, the present disclosure is not limited thereto, features of the open-world dataset D may be extracted and clustered using another feature extractor.

Those skilled in the art will readily appreciate that the above process is only an example of the abstracting process, and the present disclosure is not limited thereto, and that those skilled in the art may also obtain the representative data sample set S_{q} using various existing abstracting processing methods in conjunction with the concepts disclosed in the present disclosure.

It is worth noting that since the open-world data may be considered borderless, the number C of the clusters obtained in the step 112 is not necessarily equal to the number of classes to which all the open-world data correspond.

As shown in FIG. 1B, in some embodiments, acquiring the approximate dataset may comprise selecting representative data samples that match actual data in terms of: features from the representative data sample set (step 114).

The inventors have recognized that by downloading the representative data sample set to the local for comparison with the actual data and returning the comparison result, the selecting of the representative data samples having features matched can be achieved without sharing local actual data, thereby advantageously avoiding a privacy leakage risk caused by uploading the local actual data.

Thus, in some embodiments, the step 114 of selecting the representative data samples that match the actual data in terms of features may comprise exchanging information with a data processing apparatus that has access to the actual data, to determine the representative data samples that match the actual data in terms of features. The exchanged information does not contain the actual data.

An example of selecting the representative data samples (the step 114) is illustrated in detail below in conjunction with the flow diagram of FIG. 1C. Those skilled in the art will readily understand that a selecting method illustrated in FIG. 1C is only an example, and the present disclosure is not limited thereto, and those skilled in the art can also obtain the representative data samples that match the actual data in terms of features by using various existing selecting methods in conjunction with the concepts disclosed in the present disclosure.

As shown in FIG. 1C, in some embodiments, the step 114 of selecting the representative data samples that match the actual data in terms of features may comprise the following sub-steps.
step 1142, transmitting the representative data sample set to the data processing apparatus.

In some embodiments, the transmitted representative data samples may be represented by extracted features, for the purpose of one or more of improving communication efficiency, reducing communication overhead, reducing local storage burden, and the like. However, the present disclosure is not limited thereto, for example, the transmitted representative data samples may also be data samples in an original format.
step 1144, receiving matching results of the representative data samples from the data processing apparatus. The matching result of each representative data sample is based on a statistical similarity of the representative data sample with the actual data in terms of features.

In some embodiments, features of the actual data may also be extracted using the pre-trained model. Thus, the neural network ø can also be transmitted to the data processing apparatus that has access to the actual data.

For example, the matching result of each representative data sample may be based on a statistical sum or average of similarities of the representative data sample with all the actual data in terms of features. In some examples, a similarity of the representative data sample with any actual data may be represented with a numerical value, wherein a magnitude of the numerical value reflects a degree of matching with the actual data in terms of features. For example, the similarity of the representative data sample with any actual data can be represented with a discrete numerical value of 0 or 1, wherein for any actual data, a similarity of a representative data sample that most matches the actual data in terms of features is 1, and a similarity of other representative data samples is 0. In this case, the larger the statistical sum or average of the similarities (statistical similarity) of the representative data sample, it is indicated that the more actual data the representative data sample most matches, that is, the higher the degree of matching. In this example, the statistical similarity of the representative data sample c may be represented by:

$${V}_{c} = \# \{ {I}_{j} ∈ {S}_{p} \vert c = arg {min}_{{c}^{′}} {‖ ϕ ( {I}_{{c}^{′}} ) - ϕ ( {I}_{j} ) ‖}^{2} , {I}_{{c}^{′}} ∈ {S}_{q} \} \qquad [ Equation l ]$$

where Sₚ denotes the actual dataset, and V_{c} denotes the number of votes of most matching the actual data, which are obtained by the representative data sample c, for indicating the statistical similarity thereof.

The inventors have recognized that the statistical similarity of each representative data sample with the actual data in terms of features may also contain part of privacy information of the actual data.

Therefore, in some embodiments, the matching result of each representative data sample may be obtained by performing differential privacy processing A_{ε}(V_{c}) or other privacy protection processing on the corresponding statistical similarity. However, the present disclosure is not limited thereto, for example, the matching result may be directly represented by the corresponding statistical similarity.

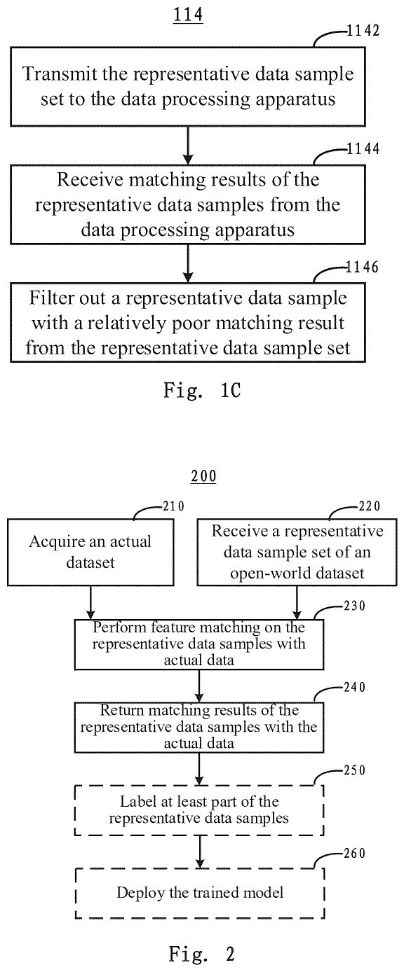

A specific example of determining the matching result will be described in detail later in conjunction with FIG. 2.

Those skilled in the art will readily appreciate that the definition of the matching result described above is merely an example, and the present disclosure is not limited thereto, and that those skilled in the art may also define the matching result in another manner in conjunction with the concepts disclosed in the present disclosure.
step 1146, filtering out a representative data sample with a relatively poor matching result from the representative data sample set.

In some embodiments, it is possible to rank the matching results of the representative data samples and filter out representative data samples with lower ranking matching results from the representative data sample set. Alternatively, in some embodiments, a representative data sample with a matching result having a numerical value less than a preset threshold may be filtered out from the representative data sample set. For example, in case where the statistical similarity is obtained by the above Equation 1, a representative data sample with a matching result of 0 or close to 0 due to addition of random perturbation may be filtered out.

Since the representative data samples selected in the step 114 matches the actual data in terms of features, it may be considered that classes to which the selected representative data samples correspond are classes included in the actual dataset. It is worth noting, however, that since the number of the classes of the actual data is unknown, the number of the selected classes is not necessarily equal to the number of the classes of the actual data.

Alternatively, in some embodiments, the received matching result is only related to the already selected representative data sample. Therefore, there is no need to perform the step 1146.

The inventors have recognized that in addition to the selected representative data samples themselves, the approximate dataset may also include other open-world data that match the selected representative data samples in terms of features, to provide a large amount of data for model training, thereby ensuring the accuracy of the trained model.

Thus, as shown in FIG. 1B, in some embodiments, acquiring the approximate dataset may further comprise, based on the selected representative data samples, supplementarily collecting correlated open-world data to expand the approximate dataset (step 116).

In some embodiments, the correlated open-world data is open-world data that matches the selected representative data samples in terms of features. Clustering and feature extraction may also be performed using the pre-trained model.

For example, for each selected representative data sample, data may be randomly collected in a class of the representative data samples. Further, data closer to the selected representative data sample may be preferentially selected based on a degree of feature matching.

In some embodiments, it is possible to continue to supplement the collection of data in the open-world dataset D. Alternatively, supplementary data collection may be performed in another open-world dataset. For example, supplementary collection may be performed in a larger open-world dataset to ensure sufficiency and richness of the data.

The inventors have also recognized that the matching result of the selected representative data sample can basically reflect a distribution proportion of the actual data. Specifically, in case where the value of the matching result is in positive correlation with the degree of matching, the higher matching result of the representative data sample is, the higher data proportion of a class to which the representative data sample belongs in the actual data may be. Thus, the supplementary data collection in correlation with the matching result facilitates obtaining an approximate dataset that is more similar to the data distribution of the actual dataset.

Therefore, in some embodiments, the step 116 of expanding the approximate dataset comprises collecting, in correlation with the matching result of each selected representative data sample, data that matches the selected representative data sample in terms of features. In case where the value of the matching result is in positive correlation with the degree of matching, “in correlation” may include “in proportion” or “approximately in proportion”. Thus, the more the representative data sample matches the actual data, the more the open-world data collected in the class of the representative data sample.

An approximate dataset De composed of a large amount of open-world data, which is approximate to the actual dataset, may be obtained by the step 116.

As shown in FIG. 1A, in the step 120, the model is trained using the approximate dataset D_{c}.

In various embodiments, training the model in the step 120 may include one or more of retraining the model, tuning the model, updating the model, and the like.

Assuming that an initial model is a pre-trained model f_{θ}, where θ is a parameter of the pre-trained model, and a learning rate of the training is r, then by using the approximate dataset D_{c′} the model can be trained by:

$$θ ← θ - r {∇}_{θ} ( L ( {f}_{θ} , B ) ) \qquad [ Equation 2 ]$$

where B is a batch sample randomly extracted from D_{c}.

By repeating the above fine-tuning process several times, the training of the model can be achieved.

In addition, in some embodiments, the steps 110-120 may be repeatedly performed to tune the trained model for the updated actual data, thereby better adapting to an actual situation and reducing the workload required for retraining the model each time.

As shown in FIG. 1A, optionally, in some embodiments, the method 100 for training a model further comprises performing model compression on the trained model (step 140).

Advantageously, compressing the model using a model compression technique before model deployment may not only further reduce a model size, making the model more applicable to an apparatus such as an edge computing device, but also further reduce model privacy leakage.

In some embodiments, the method 100 for training a model further comprises distributing the trained model to a correlated data processing apparatus (step 150).

Here, “correlated” with the actual dataset means that data to be processed by the data processing apparatus using the trained model has the same distribution as the actual dataset. For example, customers in different areas within a same supermarket may have different access features, so that there is a difference in customer data collected from image sensors arranged in the different areas, and data to be processed by an image sensor located in a certain area has the same distribution as an actual customer dataset collected by the image sensor of the area. Thus, the trained model may have a better performance on the data to be processed.

In some embodiments, the method 100 for training a model further comprises obtaining the trained model obtained by performing the above steps.

According to an embodiment of the present disclosure, a method for generating a model may comprise generating a model by performing the steps of the method for training a model according to the embodiment of the present disclosure.

FIG. 2 illustrates a flow diagram of an example of steps of a data processing method according to an embodiment of the present disclosure. The contents described above in conjunction with FIGS. 1A to 1C may also be applied to the corresponding features, so that the description of part of repeated contents will be omitted.

The data processing method according to the embodiment of the present disclosure may be performed by any apparatus including a processing device, for example, by a low-power computing device (a local edge device such as an image sensor).

As shown in FIG. 2A, according to the embodiment of the present disclosure, the data processing method 200 may mainly comprise the following steps:
step 210, acquiring an actual dataset;
step 220, receiving a representative data sample set of an open-world dataset;
step 230, performing feature matching on the representative data samples with actual data; and
step 240, returning matching results of the representative data samples with the actual data.

In some embodiments, in the step 210, the actual dataset Sₚ may be acquired by directly collecting data. For example, in some examples, real image data may be acquired through image capture. Alternatively, in some embodiments, the actual dataset Sₚ may be acquired from an external device in a manner that is secure with respect to privacy information.

In some embodiments, the data processing method 200 may further comprise performing feature extraction on the acquired actual dataset to facilitate feature matching.

In some embodiments, the above neural network φ that is obtained by removing the last layer of the pre-trained neural network f_{θ} and retaining the penultimate layer thereof may be taken as the feature extractor. Accordingly, the data processing method 200 may further comprise receiving the neural network φ. However, those skilled in the art will readily appreciate that the present disclosure is not limited thereto.

In some embodiments, in step 220, a representative data sample set S_{q} of the open-world dataset D may be received from a high-computing power computing device (such as a cloud server).

As described above, in some embodiments, the representative data sample set S_{q} may be obtained by abstracting the open-world dataset D. For example, the representative data sample set S_{q} may include cluster centers of C clusters in total that are obtained by performing feature extraction and clustering using a feature extractor such as the neural network φ, but the present disclosure is not limited thereto.

As described above, in some embodiments, the received representative data samples S_{q} may be data samples represented by the extracted features, but the present disclosure is not limited thereto.

In some embodiments, performing feature matching (step 230) comprises calculating a statistical similarity of each representative data sample with the actual data in terms of features.

For example, a statistical sum or average of similarities of each representative data sample with all the actual data in terms of features may be calculated as the statistical similarity. As described above, in some examples, a similarity of a representative data sample with any actual data may be represented with a numerical value, wherein a magnitude of the numerical value reflects a degree of matching with the actual data in terms of features. For example, the similarity of the representative data sample with any actual data may be represented using a discrete numerical value of 0 or 1, wherein for any actual data, a similarity of a representative data sample that most matches the actual data in terms of features is set to 1, and a similarity of other representative data samples is set to 0. In this case, the larger the statistical sum or average of the similarities (statistical similarity) of the representative data sample, it is indicated that the more actual data the representative data sample most matches, that is, the higher degree of matching. In this example, the statistical similarity of the representative data sample may be calculated using the number of votes in the above Equation 1. However, those skilled in the art will readily appreciate that the present disclosure is not limited thereto.

In some embodiments, performing feature matching further comprises performing differential privacy processing on the statistical similarity.

The matching result of each representative data sample can be obtained by performing differential privacy processing A_{ε}(V_{c}) on the corresponding statistical similarity. For example, it is possible to add a random Gaussian perturbation into the statistical similarity of each representative data sample and calculate a corresponding differential privacy risk. If a privacy loss is within an acceptable range, the matching result is obtained. But the present disclosure is not limited thereto, for example, another privacy protection technique may be used for the statistical similarity or the statistical similarity may be directly determined as the matching result.

Those skilled in the art will readily appreciate that the method of performing feature matching described above is only an example, and the present disclosure is not limited thereto, and that various methods of feature matching may be used by those skilled in the art in conjunction with the concepts disclosed in the present disclosure.

In the case where the processed open-world data has no labels but the actual data has labels, in some embodiments, the data processing method 200 may further comprise labeling (step 250) at least part of the representative data samples. For example, the representative data samples that match the actual data in terms of features are labeled. Thus, in some embodiments, the data processing method 200 may further comprise, after returning matching results of the representative data samples with the actual data (step 240), receiving the representative data samples that match the actual data in terms of features or information in correlation with the representative data samples.

In some embodiments, labeling (step 250) the representative data sample may comprise calculating class similarities of the representative data sample with classes of actual data in terms of features, respectively; and determining a class to which the representative data belongs based on ranking of the class similarities by magnitude.

The class similarity of the representative data sample with each class of actual data in terms of features can be represented using the quantity of actual data in the class of actual data that matches the representative data sample in terms of features.

For example, the representative data sample may be labeled using a nearest neighbor pseudo labeling method.

Assuming that there are K classes of actual data and for a representative data sample x, a m-near neighbor set of x is represented with [symbol] ₘ(x), where m is an optional hyper-parameter, labeling can be performed according to the following Equation 3:

### [Equation 3]

$$f ( x ) = arg {max}_{k ∈ [ K \}} {A}_{ϵ} ( {v}_{k} ) ,$$

$${v}_{k} = \vert \{ ( {x}^{′} , {y}^{′} ) ∈ {ℕ}_{m} ( x ) \vert {y}^{′} = k \} \vert ∘$$

where Vₖ denotes the quantity of actual data of a k-th class that satisfies a nearest neighbor requirement of the representative data sample x (the number of votes), which represents a class similarity of the sample x. A_{ε}(Vₖ) performs noise privacy processing on the number of votes, and calculates a privacy risk ε. f(x) denotes a selected class for which the maximum number of votes is obtained, i.e., a class with which the representative data x is to be labeled.

According to the above labeling method, nearest neighbor pseudo labels can be provided for selected open-world data without labels using local actual data labels, favorably reducing the workload of the labeling task and improving the efficiency of the model training.

Optionally, in some embodiments, the data processing method 200 may further comprise deploying the trained model obtained by performing the steps of the method for training a model according to the embodiment of the present disclosure, to process data (step 260). In view of the fact that the approximate dataset used for obtaining the trained model is similar to the actual dataset, and the data to be processed has the same data distribution as the actual dataset, deploying the trained model will be beneficial to improving the adaptability and accuracy of the model for an actual application scenario.

It is worth noting that boundaries between various steps in the method described above are merely illustrative. In practical operations, the steps can be combined arbitrarily, even into a single step. In addition, the execution order of the steps is not limited to the described order, and part of the steps may be omitted. The operational steps of the embodiments may also be combined with one another in any appropriate order, thereby similarly realizing more or less operations than those described.

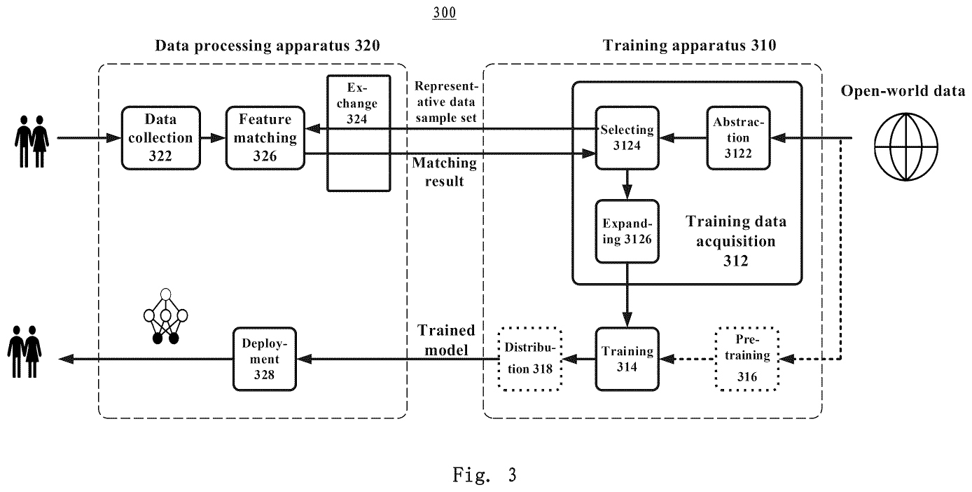

A system for training a model, a training apparatus and a data processing apparatus according to an embodiment of the present disclosure are exemplarily described below in conjunction with FIG. 3. For ease of understanding, FIG. 3 also illustrates main functional modules of each apparatus and their information exchange.

According to the embodiment of the present disclosure, a system 300 for training a model may comprise a training apparatus 310 and a data processing apparatus 320. In some embodiments, the training apparatus 310 is a high-computing power computing device (such as a cloud server), while the data processing apparatus 320 is a low-power computing device (a local edge device such as an image sensor).

In some embodiments, the training apparatus 310 may transmit a representative data sample set abstracted from an open-world dataset to the data processing apparatus 320, to generate an approximate dataset according to a returned matching result with the actual data, and train a model using the approximate dataset, so that the performance of the model on the actual data can be improved. In an open world, a large number of data samples can be advantageously provided. Accordingly, the data processing apparatus 320 only needs to perform feature matching processing on the actual data locally, without the need to share the actual data or perform model training with a high-computing power requirement. The trained model may be deployed on the data processing apparatus 320. Therefore, in the process of training the model, privacy information of the actual data will not be leaked, and the accuracy and practical application value of the trained model can be guaranteed at the same time.

In particular, in various embodiments, the training apparatus 310 may be configured to perform the steps of the method for training a model according to the embodiment of the present disclosure. The contents described above in conjunction with FIGS. 1A to 1C and FIG. 2 may also be applied to the corresponding features, so that the description of part of repeated contents will be omitted.

In the embodiment of the present disclosure, as shown in FIG. 3, the training apparatus 310 may comprise:
a training data acquisition module 312, configured to acquire an approximate dataset composed of open-world data, which is similar to an actual dataset; and
a training module 314, configured to train a model using the approximate dataset.

In some embodiments, the training data acquisition module 312 may comprise an abstraction sub-module 3122. The abstraction sub-module 3122 may be configured to abstract the open-world dataset to obtain the representative data sample set. For example, the abstraction sub-module 3122 may be configured to perform feature extraction and clustering on data in the open-world dataset using a pre-trained model.

In some embodiments, the training data acquisition module 312 may comprise a selecting sub-module 3124. The selecting sub-module 3124 may be configured to select representative data samples that match actual data in terms of features from the representative data sample set. For example, the selecting sub-module 3124 may be configured to exchange information with a data processing apparatus that has access to the actual data, to determine the representative data samples that match the actual data in terms of features, wherein the exchanged information does not contain the actual data. That is, the processing on the actual data is performed only locally, and the actual data is not uploaded. It is worth noting that, although the data processing apparatus for information exchange with the selecting sub-module 3124 illustrated in FIG. 3 is the data processing apparatus 320 according to the embodiment of the present disclosure, the present disclosure is not limited thereto. It will be readily appreciated by those skilled in the art that the data processing apparatus may be any data processing apparatus that collects and/or stores the actual data and therefore can securely access the actual data without leaking privacy information.

In some examples, the selecting sub-module 3124 may be configured to transmit the representative data sample set to the data processing apparatus and receive matching results of the representative data samples from the data processing apparatus. The matching result of each representative data sample may be based on a statistical similarity of the representative data sample with the actual data in terms of features. Then, the selecting sub-module 3124 may be configured to filter out a representative data sample with a relatively poor matching result from the representative data sample set.

Alternatively, in some embodiments, the selecting sub-module 3124 may receive only the matching results of the selected representative data samples. That is, relatively poor matching results have been filtered out. Thus, the selecting sub-module 3124 may no longer perform the filtering operation.

In some embodiments, the training data acquisition module 312 may further comprise an expansion sub-module 3126. The expansion sub-module 3126 may be configured to, based on the selected representative data samples, supplementarily collect correlated open-world data, to expand the approximate dataset. For example, the expansion sub-module 3126 may be configured to collect, in correlation with the matching result of each selected representative data sample, data that matches the representative data sample in terms of features.

In some embodiments, the training apparatus 310 may further comprise a pre-training module 316. The pre-training module 316 may be configured to acquire a pre-trained model. Thus, the training module 314 may be configured to tune the pre-trained model using the approximate dataset.

In some embodiments, the training apparatus 310 may further comprise a model distribution module 318. The model distribution module 318 is configured to distribute the trained model to an apparatus in correlation with the actual dataset. Here, “correlated” with the actual dataset means that data to be processed by the apparatus using the trained model has the same distribution as the actual dataset. For example, the correlated apparatus may be the data processing apparatus that exchange information with the training apparatus 310 to provide the matching result, but the present disclosure is not limited thereto.

Optionally, in some embodiments, the training apparatus 310 may further comprise a model compression module (not shown). The model compression module is configured to compress the model using a model compression technique.

In particular, in various embodiments, the data processing apparatus 320 may be configured to perform the steps of the data processing method according to the embodiment of the present disclosure. The contents described above in conjunction with FIGS. 1A to 1C and FIG. 2 may also be applied to the corresponding features, and the description of part of repeated contents will be omitted.

In the embodiment of the present disclosure, as shown in FIG. 3, the data processing apparatus 320 may comprise:
a data collection module 322, configured to acquire the actual dataset;
an exchange module 324, configured to receive the representative data sample set of the open-world dataset; and
a feature matching module 326, configured to perform feature matching on the representative data samples with the actual data;
wherein the exchange module 324 is further configured to return matching results of the representative data samples with the actual data.

In some embodiments, the data collection module 322 may further be configured to perform feature extraction on the acquired actual dataset.

In some embodiments, the data processing apparatus 320 may further comprise a deployment module 328. The deployment module 328 may be configured to deploy the trained model that is obtained by performing the steps of the method for training a model according to the embodiment of the present disclosure, i.e., the trained model obtained by the training apparatus 310, to process data.

In some embodiments, the feature matching module 326 may be configured to calculate a statistical similarity of each representative data sample with the actual data in terms of features and determine a matching result based on the statistical similarity. In some embodiments, the feature matching module 326 may further be configured to perform differential privacy processing on the statistical similarity. The related contents have been discussed in detail above, and will not be repeated here.

Then, the data processing apparatus 320 may return the matching result through the exchange module 324. Thus, the data processing apparatus 320 only needs to perform feature matching process on the actual data locally, without the need to share the actual data or perform model training with a high-computing power requirement.

In some embodiments, the data processing apparatus 320 may further comprise a labeling module (not shown). The labeling module can be configured to label at least part of the representative data samples.

In some embodiments, the labeling module may be configured to calculate class similarities of the representative data sample with classes of actual data in terms of features, respectively; and determining a class to which the representative data belongs based on ranking of the class similarities by magnitude. In some embodiments, the labeling module may be further configured to perform differential privacy processing on the class similarities before the ranking. The related contents have been discussed in detail above, and will not be repeated here.

Although the training apparatus 310 and the data processing apparatus 320 are depicted together in FIG. 3, those skilled in the art will readily appreciate that the present disclosure is not limited thereto. In fact, in many cases, the training apparatus 310 is provided in a cloud, while the data processing apparatus 320 is provided locally.

Furthermore, it should be understood by those skilled in the art that although only one data processing apparatus 320 is illustrated in FIG. 3, the number of data processing apparatuses is not limited thereto. For example, in some embodiments, the system 300 may include a plurality of data processing apparatuses 320. The training apparatus 310 may perform feature matching by means of each of these data processing apparatuses 320, respectively, to determine an approximate dataset, and distribute and deploy a model trained on the approximate dataset to a corresponding apparatus. Here, the “corresponding” apparatus means that data to be processed by the apparatus where the model is deployed has a similar distribution to the approximate dataset used for training to obtain the model.

The system 300 illustrated in FIG. 3 may be applied in a variety of scenarios, particularly business scenarios for a variety of computer vision classification tasks.

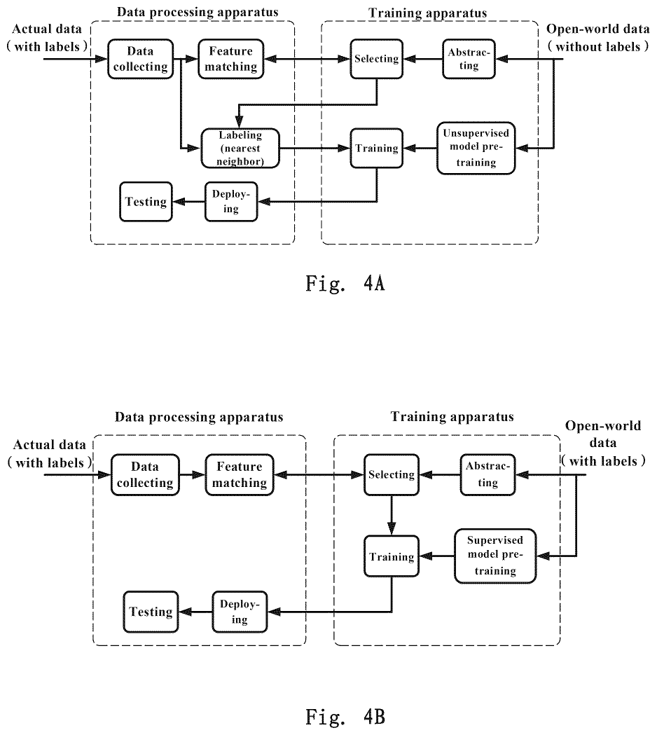

FIGS. 4A-4C illustrate an example of a learning scenario for a solution for training a model according to an embodiment of the present disclosure. In FIGS. 4A-4C, some functional modules and exchange therebetween are simplified for ease of understanding, but those skilled in the art will readily appreciate that the present disclosure is not limited thereto.

In the example shown in FIG. 4A, open-world data without labels is labeled using labels of local actual data, e.g., nearest neighbor pseudo labels are provided. In this way, in the model training solution according to the embodiment of the present disclosure, it is possible to perform semi-supervised learning to train a model. In this example, cloud data with a very large distribution difference can be filtered out by feature matching, to reduce data to be labeled and reduce noise of a near neighbor pseudo labeling algorithm brought by samples outside the distribution, thereby improving the efficiency of the semi-supervised learning.

In the example shown in FIG. 4B, the processed open-world data has labels. In this way, in the model training solution according to the embodiment of the present disclosure, it is possible to first perform pre-training of a model on the open-world data (e.g., ImageNet) different from actual data in distribution, and then perform supervised tuning training.

In the example shown in FIG. 4C, both the processed open-world data and the actual data have no labels. In this way, in the model training solution according to the embodiment of the present disclosure, it is possible to perform manual labeling by using outsourcing services after selecting, thereby performing semi-supervised learning with a small number of labeled samples. Advantageously, by selecting data to be labeled, the number of public samples to be labeled and the labor cost can be reduced.

Those skilled in the art should d appreciate that the application of the solution for training a model is not limited to the above examples.

An embodiment of the present disclosure further provides a computer-readable storage medium having one or more instructions stored thereon that, when executed by a processor, cause the processor to perform the steps of the method for training a model or the data processing method in the above embodiments.

An embodiment of the present disclosure further provides a computer program product comprising one or more instructions that, when executed by a processor, cause the processor to perform the steps of the method for training a model or the data processing method in the above embodiments.

It should be understood that the instructions in the computer-readable storage medium according to the embodiment of the present disclosure may be configured to perform operations corresponding to the above system and method embodiments. When referring to the above system and method embodiments, the embodiment of the computer-readable storage medium will be apparent to those skilled in the art, and therefore will not be repeated. The computer-readable storage medium for carrying or including the above instructions also falls within the scope of the present disclosure. Such a computer-readable storage medium may include, but is not limited to, a floppy disk, optical disk, magneto-optical disk, memory card, memory stick, and the like.

The embodiments of the present disclosure also provide various devices including components or units for performing the steps of the method for training a model or the data processing method in the above embodiments.

It should be noted that the above components or units are only logic modules divided according to the specific functions implemented by the components or units, and are not used for limiting specific implementations, for example, they may be implemented in software, hardware or a combination of software and hardware. In actual implementations, the above components or units may be implemented as separate physical entities, or may also be implemented by a single entity (e.g., a processor (CPU or DSP, etc.), an integrated circuit, etc.). For example, a plurality of functions included in one unit in the above embodiments may be implemented by separate devices. Alternatively, a plurality of functions implemented by a plurality of units in the above embodiments may be implemented by separate devices, respectively. In addition, one of the above functions may be implemented by a plurality of units.

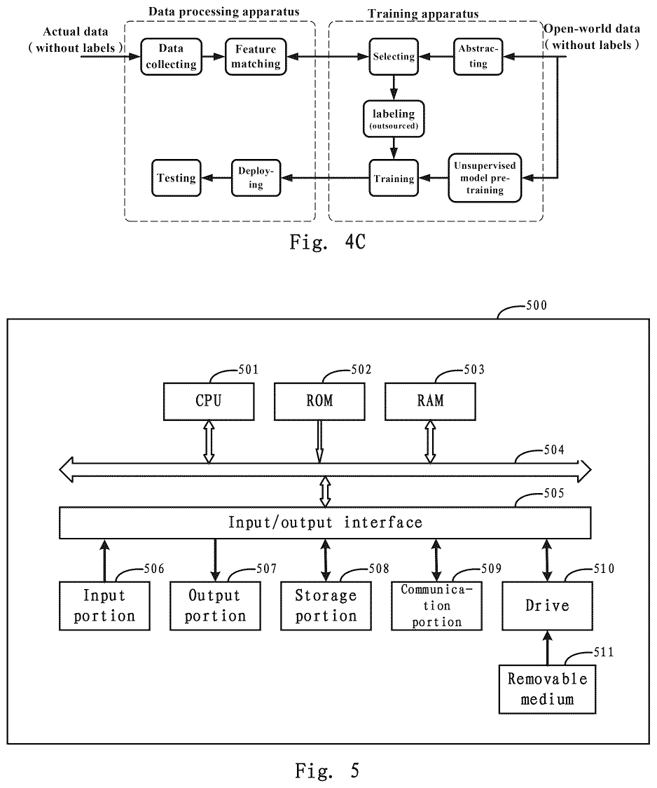

In addition, it should be understood that the above series of processes and apparatuses may also be implemented by software and/or firmware. In the case of implementation by software and/or firmware, a program constituting the software is installed from a storage medium or a network to a computer having a dedicated hardware structure, such as a general-purpose computer 500 shown in FIG. 5, which is capable of executing various functions and the like when having various programs installed thereon. FIG. 5 illustrates an example block diagram of a computer that can be implemented as a training apparatus, application apparatus, and system according to an embodiment of the present disclosure.

In FIG. 5, a central processing unit (CPU) 501 executes various processes according to a program stored in a read-only memory (ROM) 502 or a program loaded from a storage portion 508 to a random access memory (RAM) 503. In the RAM 503, data required when the CPU 501 executes various processes and the like is also stored as needed.

The CPU 501, ROM 502, and RAM 503 are connected to each other via a bus 504. An input/output interface 505 is also connected to the bus 504.

The following components are connected to the input/output interface 505: an input portion 506, including a keyboard, a mouse, etc.; an output portion 507, including a display such as a cathode ray tube (CRT) and a liquid crystal display (LCD), and a speaker, etc.; the storage portion 508, including a hard disk, etc.; and a communication portion 509, including a network interface card such as a LAN card and a modem. The communication portion 509 performs communication processing via a network such as the Internet.

A drive 510 is also connected to the input/output interface 505 as needed. A removable medium 511, such as a magnetic disk, an optical disk, a magneto-optical disk, or a semiconductor memory, is mounted on the drive 510 as needed, so that a computer program read out therefrom is installed into the storage portion 508 as needed.

In case where the above series of processes are implemented by software, a program constituting the software is installed from a network such as the Internet or a storage medium such as the removable medium 511.

It should be understood by those skilled in the art that such a storage medium is not limited to the removable medium 511 shown in FIG. 5 that has the program stored therein and is distributed separately from the apparatus to provide the program to the user. Examples of the removable medium 511 include a magnetic disk (including a floppy disk (registered trademark)), an optical disk (including a compact disk read-only memory (CD-ROM) and a digital versatile disk (DVD)), a magneto-optical disk (including a mini disk (MD) (registered trademark)), and a semiconductor memory. Alternatively, the storage medium may be the ROM 502, a hard disk included in the storage portion 508, or the like, which has the program stored therein and is distributed to a user together with the apparatus including them.

The exemplary embodiments of the present disclosure are described above with reference to the drawings, but the present disclosure is of course not limited to the above examples. Various changes and modifications may be obtained by those skilled in the art within the scope of the appended claims, and it should be understood that these changes and modifications will naturally fall within the technical scope of the present disclosure.

Although the present disclosure and its advantages have been described in detail, it should be understood that various changes, substitutions and alterations can be made herein without departing from the spirit and scope of the present disclosure defined by the appended claims. Moreover, the terms “comprise”, “include”, or any other variation thereof in the embodiments of the present disclosure are intended to cover a non-exclusive inclusion, such that a process, method, article, or apparatus that comprises a series of elements includes not only those elements, but also other elements not expressly listed or elements inherent to such a process, method, article, or apparatus. Without further limitation, an element defined by the statement “comprising an . . . ” does not exclude the presence of another identical element in the process, method, article, or apparatus that comprises the element.

The embodiment of the present disclosure further comprises:

1. A method for training a model, comprising:
acquiring an approximate dataset composed of open-world data, which is similar to an actual dataset; and
training a model using the approximate dataset.

2. The model training method of item 1, wherein, the acquiring the approximate dataset comprises:
abstracting an open-world dataset to obtain a representative data sample set; and
selecting representative data samples that match actual data in terms of features from the representative data sample set.

3. The method of item 2, wherein, the acquiring the approximate dataset further comprises:
based on the selected representative data samples, supplementarily collecting correlated open-world data, to expand the approximate dataset.

4. The method of item 2, wherein, the abstracting the open-world dataset comprises:
performing feature extraction and clustering on data in the open-world dataset using a pre-trained model.

5. The method of item 2, wherein, the selecting the representative data samples that match the actual data in terms of features comprises:
exchanging information with a data processing apparatus that has access to the actual data, to determine the representative data samples that match the actual data in terms of features, wherein the exchanged information does not contain the actual data.

6. The method of item 3, wherein, the expanding the approximate dataset comprises:
collecting, in correlation with a matching result of each selected representative data sample, data that matches the representative data sample in terms of features, wherein the matching result of each representative data sample is based on a statistical similarity of the representative data sample with the actual data in terms of features.

7. The method of item 1, further comprising acquiring a pre-trained model,
wherein the training the model using the approximate dataset comprises tuning the pre-trained model using the approximate dataset.

8. A data processing method, comprising:
acquiring an actual dataset;
receiving a representative data sample set of an open-world dataset;
performing feature matching on representative data samples with actual data; and
returning matching results of the representative data sample with the actual data.

9. The method of item 8, further comprising: deploying the trained model obtained by performing the method according to any of items 1-7, to process data.

10. The method of item 8, wherein the performing feature matching comprises:
calculating a statistical similarity of each representative data sample with the actual data in terms of features, and determining the matching result based on the statistical similarity.

11. The method of item 10, wherein the performing feature matching further comprises:
performing differential privacy processing on the statistical similarity.

12. The method of item 8, further comprising:
labeling at least part of the representative data samples.

13. The method of item 12, wherein, the labeling the representative data comprises:
calculating class similarities of the representative data sample with classes of actual data in terms of features, respectively; and
determining a class to which the representative data belongs based on ranking of the class similarities by magnitude.

14. The method of item 13, wherein, the labeling the representative data further comprises:
before the ranking, performing differential privacy processing on the class similarities.

15. An training apparatus, comprising:
a training data acquisition module, configured to acquire an approximate dataset composed of open-world data, which is similar to an actual dataset; and
a training module, configured to train a model using the approximate dataset.

16. A data processing apparatus comprising:
a data collection module, configured to acquire an actual dataset;
an exchange module, configured to receive a representative data sample set of an open-world dataset; and
a feature matching module, configured to perform feature matching on representative data samples with actual data;
wherein the exchange module is further configured to return matching results of the representative data samples with the actual data.

17. A system for training a model, comprising:
the training apparatus of item 15; and
the data processing apparatus of item 16.

18. A computer-readable storage medium having one or more instructions stored thereon that, when executed by a processor, cause the processor to perform the steps of the method according to any of items 1-7 and/or the steps of the method according to any of items 8-14.

19. A computer program product comprising one or more instructions that, when executed by a processor, cause the processor to perform the steps of the method according to any of items 1-7 and/or the steps of the method according to any of items 8-14. 20. A method for generating a model, comprising: generating a model by performing the steps of the method of any of items 1-7.

1. A method for training a model, comprising:
acquiring an approximate dataset composed of open-world data, which is similar to an actual dataset; and
training a model using the approximate dataset.

2. The method of claim 1, wherein, the acquiring the approximate dataset comprises:
abstracting an open-world dataset to obtain a representative data sample set; and
selecting representative data samples that match actual data in terms of features from the representative data sample set.

3. The method of claim 2, wherein, the acquiring the approximate dataset further comprises:
based on the selected representative data samples, supplementarily collecting correlated open-world data, to expand the approximate dataset.

4. The method of claim 2, wherein, the abstracting the open-world dataset comprises:
performing feature extraction and clustering on data in the open-world dataset using a pre-trained model.

5. The method of claim 2, wherein, the selecting the representative data samples that match the actual data in terms of features comprises:
exchanging information with a data processing apparatus that has access to the actual data, to determine the representative data samples that match the actual data in terms of features, wherein the exchanged information does not contain the actual data.

6. The method of claim 3, wherein the expanding the approximate dataset comprises:
collecting, in correlation with a matching result of each selected representative data sample, data that matches the representative data sample in terms of features, wherein the matching result of each representative data sample is based on a statistical similarity of the representative data sample with the actual data in terms of features.

7. The method of claim 1, further comprising acquiring a pre-trained model,
wherein the training the model using the approximate dataset comprises tuning the pre-trained model using the approximate dataset.

8. A data processing method, comprising:
acquiring an actual dataset;
receiving a representative data sample set of an open-world dataset;
performing feature matching on representative data samples with actual data; and
returning matching results of the representative data samples with the actual data.

9. (canceled)

10. The method of claim 8, wherein, the performing feature matching comprises:
calculating a statistical similarity of each representative data sample with the actual data in terms of features, and determining the matching result based on the statistical similarity.

11. The method of claim 10, wherein, the performing feature matching further comprises:
performing differential privacy processing on the statistical similarity.

12. The method of claim 8, further comprising:
labeling at least part of the representative data samples.

13. The method of claim 12, wherein, the labeling the representative data sample comprises:
calculating class similarities of the representative data sample with classes of actual data in terms of features, respectively; and
determining a class to which the representative data belongs based on ranking of the class similarities by magnitude.

14. The method of claim 13, wherein, the labeling the representative data further comprises:
before the ranking, performing differential privacy processing on the class similarities.

15.-17. (canceled)

18. A computer-readable storage medium having one or more instructions stored thereon that, when executed by a processor, cause the processor to perform the steps of:
acquiring an approximate dataset composed of open-world data, which is similar to an actual dataset; and
training a model using the approximate dataset.

19. (canceled)

20. A method for generating a model, comprising: generating a model by performing the steps of the method of claim 1.

21. A computer-readable storage medium having one or more instructions stored thereon that, when executed by a processor, cause the processor to perform the steps of the method of claim 8.
